(19) United States
(12) Patent Application Publication
(10) Pub. No.: US 2026/0264244 A1
(43) Pub. Date: Sep. 10, 2026

(54) METHOD FOR CARRYING OUT INDUSTRIAL WORKING OPERATIONS WITHIN A WORK ENVIRONMENT, AND RELATED SYSTEM

(71) Applicants: Comau S.p.A., Grugliasco (Torino) (IT); Fincantieri S.p.A., Trieste (IT)

(72) Inventors: Francesco CINIELLO, Grugliasco (Torino) (IT); Gerardo RENGA, Grugliasco (Torino) (IT); Gian Paolo GERIO, Grugliasco (Torino) (IT); Andrea Rosa SENTINELLA, Grugliasco (Torino) (IT); Giovanni DI STEFANO, Grugliasco (Torino) (IT); Nicola LONGO, Grugliasco (Torino) (IT); Gianluca MONTARSOLO, Grugliasco (Torino) (IT); Viviana MARONE, Grugliasco (Torino) (IT); Alessandro NEVIEROV, Trieste (IT); Giacomo SCARPA, Trieste (IT); Marco SORIANO, Trieste (IT); Andrea UGHI, Trieste (IT); Vittorio ZANE, Trieste (IT)

(73) Assignees: Comau S.p.A., Grugliasco (Torino) (IT); Fincantieri S.p.A., Trieste (IT)

(21) Appl. No.: 18/876,374

(22) PCT Filed: Jun. 14, 2023
(86) PCT No.: PCT/IB2023/056121

§ 371 Date: Dec. 18, 2024

(30) Foreign Application Priority Data
Jun. 20, 2022 (IT) 102022000012955

(51) Int. Cl. B25J 9/16; B25J 9/00

(52) U.S. Cl. CPC B25J 9/1687; B25J 9/0081; B25J 9/162; B25J 9/1697

(57) ABSTRACT

A method for carrying out construction and/or assembly and/or maintenance and/or repair and/or inspection operations within a work environment is aided by a mobile robotic unit. The mobile robotic unit has a multi-axis manipulator robot carrying an operating head and a vehicle carrying the robot. The method includes moving the vehicle up to a predetermined work area in the work environment, and locking the vehicle at this position. A learning phase of the robot is started, wherein the operator, with the aid of a programming tool, provides an information to an electronic controller about the position in the space of a plurality of working points. A plurality of work trajectories of the operating head is processed on the basis of the information acquired on the position in the space of the working points and also on the basis of a selection from a plurality of predetermined work programs workable by the operating head.

### FIELD OF THE INVENTION

The present invention relates to a system and a related method for carrying out working operations of an industrial process within a work environment.

More specifically, the system according to the invention comprises a mobile robotic unit arranged to carry out construction and/or assembly and/or maintenance and/or repair and/or inspection operations within a work environment, for example within a ship structure or floating or semi-submersible offshore structures or inside an aircraft or inside a building structure or in an outdoor space.

The mobile robotic unit can be configured to perform any type of working with a continuous or discontinuous process, such as welding, sealing, riveting, nailing, screwing, cutting, deposition of sealant, addition of material by means of additive manufacturing technology, etc.

### PRIOR ART

A system of the type indicated above is for example described in document CN 107 030 349 A. This document in fact discloses a mobile robotic unit arranged to perform welding operations inside a work environment, in particular inside a ship. The robotic unit comprises a vehicle on which a manipulator robot equipped with a welding head is mounted.

The present invention starts from the desire to create a system and a method of the type indicated above which allows to improve the flexibility and efficiency of the execution of the working, so as to be able to carry out working cycles in a versatile, simple and fast way.

### OBJECT OF THE INVENTION

The object of the present invention is to provide a system of the type indicated above which has high flexibility and efficiency properties.

A further object of the invention is to provide a system of the type indicated above which is extremely intuitive for the operators who use it, providing detection and control techniques which are particularly simple to implement.

A further object of the invention is to make the learning operations of the system, preceding the execution of the working, extremely intuitive and fast.

### SUMMARY OF THE INVENTION

In view of achieving these objects, the invention relates to a method for carrying out construction and/or assembly and/or maintenance and/or repair and/or inspection operations within a work environment, for example within a ship structure or floating or semi-submersible offshore structures or inside an aircraft or inside a building structure or in an outdoor space, with the aid of a mobile robotic unit,
wherein the mobile robotic unit comprises:
a multi-axis manipulator robot carrying an operating head,
a vehicle carrying said robot, configured to be wire-guided or remote-controlled by an operator, or equipped with autonomous driving, wherein the method comprises the steps of:
moving the vehicle up to a work area in the work environment, and locking the vehicle at this position,
starting a learning phase of the robot, wherein the operator, with the aid of a programming tool, provides an information to an electronic controller (E) about the position in the space of a plurality of working points at which the operating head has to operate,
processing, through said electronic controller, a plurality of work trajectories of the operating head on the basis of the information acquired on the position in the space of the working points and also on the basis of a selection made by the operator, through a human-machine interface, from a plurality of predetermined work programs workable by the operating head, and contained in a memory accessible by said electronic controller, and
starting the selected work program, wherein said operating head is automatically controlled to move along the processed work trajectories.

### DETAILED DESCRIPTION OF PREFERRED EMBODIMENTS

Further features and advantages of the invention will be clear in the following description with reference to the attached drawings, provided purely by way of non-limiting example, wherein:

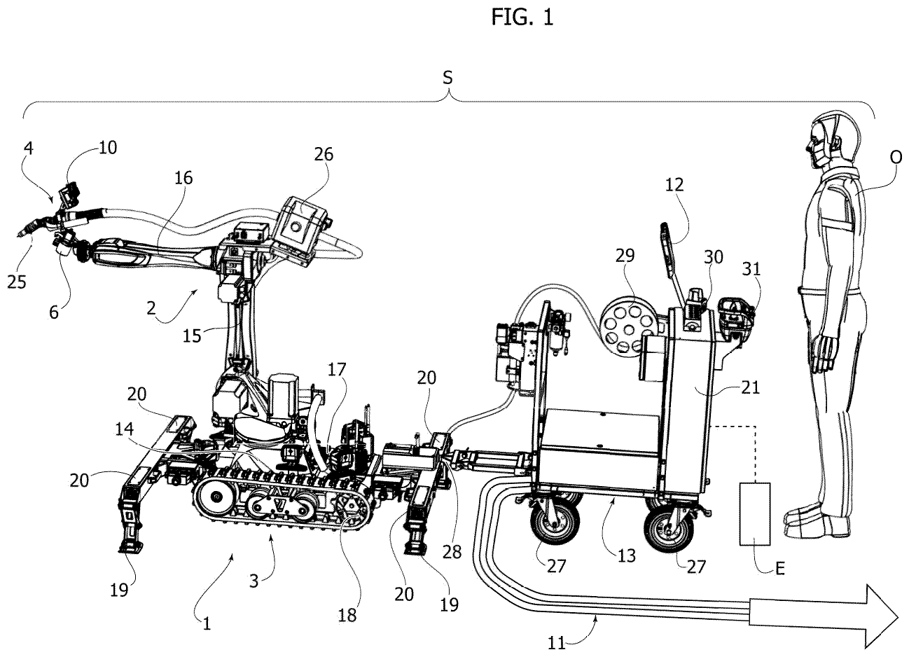

FIG. 1 is a perspective view illustrating a preferred embodiment of the system according to the invention, comprising a mobile robotic unit;

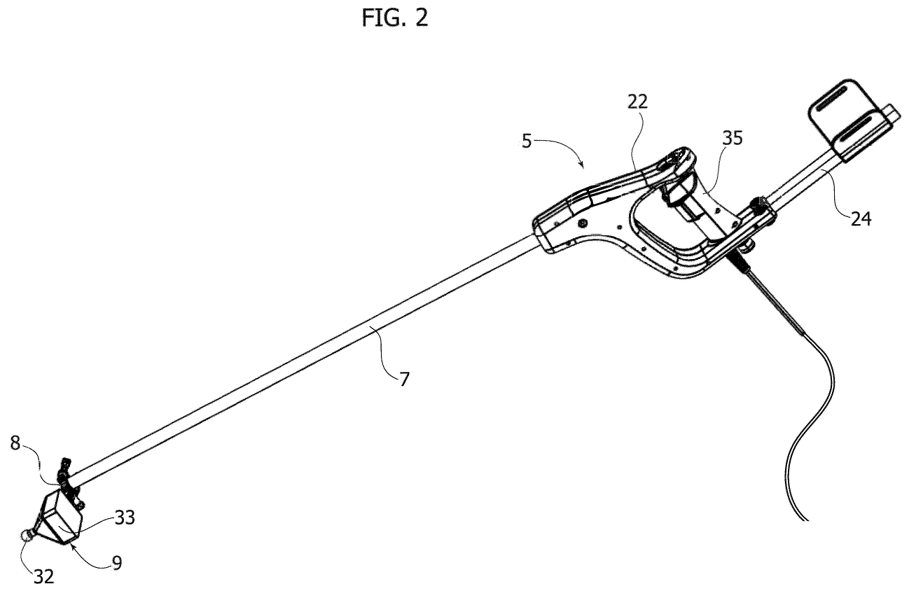

FIG. 2 is a perspective view illustrating further features of the system according to a preferred embodiment;

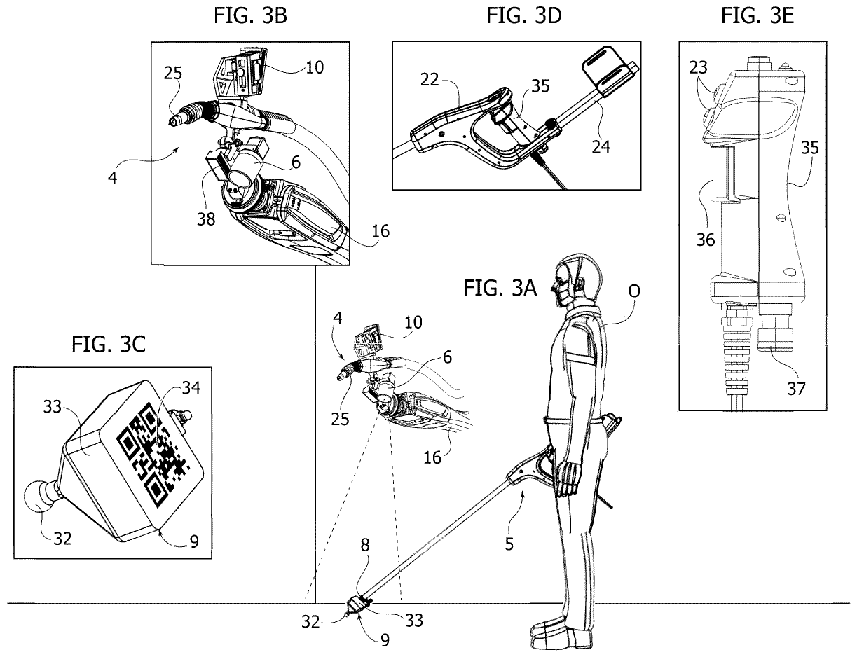

FIG. 3A is a perspective view illustrating an operational stage of operation of the system according to the invention;

FIGS. 3B-3E are enlarged scale views of some components illustrated in FIG. 3A; and

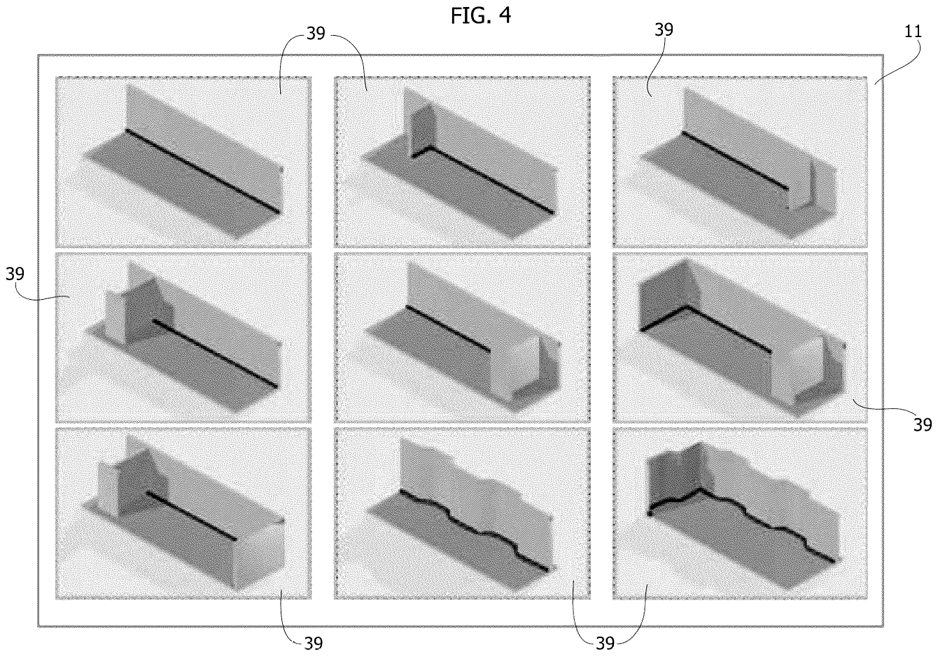

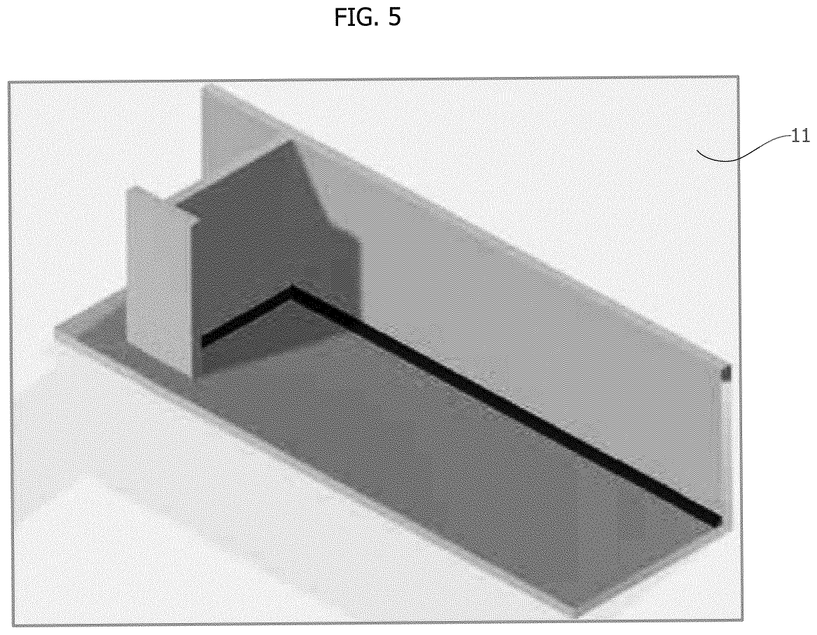

FIGS. 4, 5 are some example screens of a human-machine interface, for configuring a working cycle carried out by the system according to the invention.

Various specific details are illustrated in the following description, aimed at an in-depth understanding of examples of one or more embodiments. Embodiments may be made without one or more of the specific details, or with other methods, components, materials, etc. In other cases, known structures, materials or operations are not shown or described in detail to avoid obscuring various aspects of the embodiments. Reference to “an embodiment” or “one embodiment” within the framework of this description means that a particular configuration, structure, or feature described in connection with the embodiment is included in at least one embodiment. Thus, phrases such as “in an embodiment” or “in one embodiment,” which may appear at different places in this description, do not necessarily refer to the same embodiment. Furthermore, particular conformations, structures or features may be suitably combined in one or more embodiments and/or associated with the embodiments in a manner other than as illustrated herein, so that, for example, a feature exemplified herein in relation to a figure it can be applied to one or more embodiments exemplified in a different figure.

The references shown here are for convenience only and therefore do not limit the extent of protection or the scope of the embodiments.

With reference to FIG. 1, the reference S indicates as a whole a system for carrying out construction and/or assembly and/or maintenance and/or repair and/or inspection operations within a work environment. The system S comprises a mobile robotic unit 1 which can be configured to perform any type of working with a continuous or discontinuous process, such as for example welding, sealing, riveting, nailing, screwing, cutting, deposition of sealant, addition of material by means of additive manufacturing technology, etc.

The figures show an embodiment relating to a system S arranged to perform welding operations, in particular arc welding. This example is not to be construed as limiting in any way, since, as indicated above, the invention is applicable to any type of industrial working with a continuous or discontinuous process.

According to the invention, the mobile robotic unit 1 comprises a multi-axis manipulator robot 2 carrying an operating head 4, and a vehicle 3 on which the robot 2 is mounted. The operating head 4 comprises working means arranged to perform a plurality of construction and/or assembly and/or maintenance and/or repair operations within a work environment.

In a preferred embodiment, the work environment consists of a ship structure and the mobile robotic unit 1 and the method are set up for assembling parts of a ship under construction.

With reference to FIG. 1 wherein the mobile robotic unit 1 is shown, the robot 2 is a multi-axis manipulator robot having a base 14 and a column mounted rotatably on the base 14 about a first vertically directed axis. The robot 2 has an arm 15 mounted articulated on the column about a second horizontally directed axis; the reference 16 indicates a forearm mounted on said arm 15. The forearm 16 is articulated around a third axis which is also directed horizontally; the forearm 16 also has the possibility of rotating around its longitudinal axis, and is equipped at its end with a wrist mounted with the possibility of rotating around two mutually orthogonal axes. According to a technique known per se, each of the six axes of the robot 2 is controlled by a respective electric motor. The electric motors of the robot 2 are controlled in a manner known per se by an electronic control unit. At the distal end of the wrist of the robot 2 is provided a flange for the attachment of the operating head 4 carrying working means for the execution of working with a continuous or discontinuous process. Preferably, the attachment flange is a sensor flange to avoid any collisions. In the embodiment illustrated in FIGS. 1, 3A, the operating head 4 comprises welding means. Preferably, the welding means comprise a welding torch 25 provided to perform gas shielded metal arc welding (MIG/MAG). The reference 26 indicates a wire feeder carried by the robot 2. Of course, the invention also relates to the case wherein welding means configured to carry out other types of welding are provided (for example laser, resistance welding, etc.).

As previously indicated, the multi-axis manipulator robot 2 is carried by a vehicle 3. Again with reference to FIG. 1, the vehicle 3 comprises a frame 17 and advance/movement means 18 configured for the advance on the ground, for example metal surfaces or other material, as well as soil. Preferably, the advance/movement means 18 are a pair of tracks configured to allow easy movement of the robotic unit 1 even on deformable and inconsistent grounds. Of course, instead of the tracks, the vehicle 3 can provide other types of advance/movement means 18. The vehicle 4 also comprises a plurality of parking feet 19 supported by respective stabilizer arms 20 which extend from the frame 17. Preferably, the arms 20 are in a mutually symmetrical position with respect to the mobile robotic unit 1. The stabilizer arms 20 can be extended or folded down and can be controlled automatically by means of respective actuators to rest on the ground and keep the vehicle 3 in a stable position on the ground.

In a preferred embodiment of the invention, the vehicle 3 is configured to be wire-guided or remotely controlled by an operator O. However, it should be noted that the vehicle 3 can be configured to move automatically in a predetermined or programmed manner, to autonomously reach different zones of a work area wherein to perform various working operations.

According to what is illustrated in FIG. 1, the mobile robotic unit 1 is mechanically connected-by means of a trailer configuration-to a service trolley 13 equipped with wheels 27. In this regard, the vehicle 3 comprises a connection hinge 28 to draw the trolley 13, having a vertical support portion 21 provided to support-at an ergonomic height for the operator O various components to control the unit 1. Among the above components, there is a human-machine interface (HMI) 12 configured to allow an operator O to program and control the working cycles. According to a preferred embodiment, illustrated in FIG. 1, various electronic components are also arranged on board the carriage 13 for controlling the working cycles, including a support body 29 for supporting a reel of welding wire, a safety push-button panel 30 for safely controlling some basic functions of the working cycle, a remote control 31 for controlling the vehicle 3. The trolley 13 is connected by means of a connection cord 11 to a service unit (not shown). Cord 11 includes cables and service pipes. According to a preferred example shown, the connection is made by a pair of cords 11 coupled along their extension, so as to allow easier movement and maintenance than in the case of providing a single cord weighing more than the total weight divided between the two parallel cords.

According to a feature of the invention, the system S comprises an electronic controller E configured to start a learning phase of the robot 2, prior to the working execution. In one or more embodiments, the controller E is carried by the service trolley 13.

The learning phase includes several preliminary sub-phases, more detailed below; among these, there is a preliminary programming phase, wherein the operator O, with the aid of a programming tool 5, provides an information to the electronic controller E about the position in the space of a plurality of working points, at which the operating head 4 has to operate. In one or more embodiments, as well as in the one illustrated in FIG. 2, the programming tool 5 is a marker device provided to generate points and process trajectories automatically recognizable by the robotic unit 1. The marker device can be used manually by an operator O, in order to define the working points each time.

As illustrated in the embodiment of FIG. 2, the marker device is a rod 7 operable by the operator O, which comprises at least one pointer element 9 which acts as a marker for the robotic unit 1. The pointer element 9 is optically detectable for means of a vision device 6. In one or more embodiments, the vision device 6 is mounted on board the robot 2. In other embodiments, the vision device 6 is arranged externally to the robot 2. The rod 7 comprises a proximal portion 22 arranged to be gripped by an operator O and a terminal portion 8 including the pointer element 9 automatically recognizable by the robot 2. Preferably, the pointer element 9 is arranged at the tip of the marker device, so as to make the step of indicating the working points, performed manually by an operator O, particularly intuitive. The rod 7 can also be of the telescopic type, comprising a plurality of tubular elements configured to slide one inside the other. Thanks to this feature, the operator O can change the extension of the marker device according to the peculiarities of the work area wherein he operates and the distance from the point he intends to indicate using the pointer element 9.

As previously indicated, the manipulator robot 2 is equipped with a vision device 6 provided to detect the position of the pointer element 9. This vision device 6 can be made by the composition of optical and electronic components, for example one or more video cameras, which allow you to acquire, record and process a sequence of detected images. The result of the processing is the recognition of certain characteristics of the image, to direct the control and selection of the position of the pointer element 9. As illustrated in FIGS. 3A-3B, the vision device 6 is a video camera mounted close to the operating head 4, integral with the axes of robot 2.

According to a feature illustrated in FIGS. 3A, 3C, at the terminal end of the pointer element 9 there is a checking sphere 32 for “touching” the various elements arranged in the space of the work area. From the checking sphere 32, in the direction of the proximal portion 22, a polygonal-shaped body 33 is extended, comprising a plurality of faces, wherein at least one face shows a QR code 34 that can be read by the vision device 6. Alternatively, the pointer element 9 can comprise a three-dimensional element having a certain geometry, previously made known to the vision device 6, following a preliminary programming phase of the unit 1.

In both cases, the vision device 6 is capable of detecting and identifying the position of the pointer element 9, so as to uniquely estimate the orientation and position of the robot 2 in space.

With reference to FIGS. 3D-3E, the proximal portion 22 of the marker device comprises a handle 35, on which there are various buttons for controlling the working cycle. Among these there are:
at least one selection button 23 for giving an input command during the cycle execution, such as for example activating the search function of the pointer element 9 and identifying a specific position indicated as an obstacle to be bypassed, to avoid collisions with the head 4;
a “dead man” safety button 36, such that following pressure exceeding a given force, robot 2 stops completely;
an emergency button 37.

In other embodiments, the buttons described above are separated from the rod 7 which carries the pointer element 9.

Preferably, the marker device also comprises a support body 24 associated with the handle 35, to support the forearm of the operator O, so as to facilitate the support of the tool 5.

Thanks to the feature described above, by means of the pointer element 9 automatically recognizable by the robot 2, it is possible to make the robot 2 learn the working points on which to carry out a working operation by the operating head 4, in a particularly fast and intuitive way.

In the case of working with a continuous process, the operator O indicates with the pointer element 9 an initial point, a terminal point and a working path which extends between the initial point and the terminal point. As indicated above, the pointer element 9 is preferably arranged on the tip of the marker device. In the case that there is an obstacle along a process trajectory that is to be indicated, system S provides for the possibility of accurately detecting-between the initial point and the terminal point of the process trajectory-a point identifying the position of said obstacle. Consequently, the system S provides the functionality of automatically carrying out the working from the initial point to the terminal point, bypassing the previously identified obstacle.

In one or more embodiments, the learning phase of the robot 2 can comprise a further preliminary phase, wherein the operator O selects various operating parameters to perform the desired process, including the type of working, the angle of approach of the robot 2, the orientation of the robot 2 during the work trajectory, the speed of robot 2, etc. The selection of the various parameters made by the operator O can include a step of selection among a plurality of predetermined work programs workable by the operating head 4 and contained in a memory accessible by the electronic controller E. Further features relating to these work programs are indicated below in the description.

According to a further feature illustrated in FIGS. 1, 3A, 3B, the operating head 4 is associated with at least one opto-electronic detection system 10 for assisting the robot 2, provided to perform an automatic refinement step of the previously mentioned working points. This refinement step, which can be performed before or at the same time as the execution of the selected work program, provides that the robot 2 is controlled to move the operating head 4 so as to bring the opto-electronic detection system 10 at a position closest to said working points, while the vehicle 3 is kept stationary. With the aid of the opto-electronic detection system 10, the spatial position of the working points is refined, i.e. determined in a more precise way than the indication made with the tool 5.

Preferably, the opto-electronic detection system 10 for assisting the robot 2 comprises an emitting device configured to project a laser light blade onto the work area and a receiver device to acquire the reflected radiation. The refinement step of the work area is detected with the aid of the optoelectronic detection system 10 so as to determine, if necessary, corrections to be made to the welding parameters that are part of the selected predetermined work program. In other words, working points indicated inaccurately with the pointer element 9 can be managed with the optoelectronic detection system 10.

With reference to the enlarged view of FIG. 3A, the operating head 4 also comprises lighting means 38 in aid of the marker device for detecting the pointer element 9.

In the continuation of the description the operation of the system S described above is indicated.

According to the invention, the working cycle performed can be divided into three different operating macro-steps:
a first operating step, wherein the vehicle 3 is moved for positioning in an area of interest in the work area;
a second operating step, wherein parameters and work trajectories to be performed by robot 2 are defined; end
a third operating step, wherein the previously defined working is carried out, by means of the operating head 4.

More generally, the system S is provided to operate through an online programming mode, defining the single points (in the case of a discontinuous process) and the process trajectories (in the case of a continuous process), each time that a given working on one or more components of a work area shall be performed.

In the following, for simplicity of explanation, reference will be made to the illustrated embodiment wherein the operating head 4 comprises a welding head. Of course, as broadly indicated above, instead of the welding head, processing means suitable for carrying out other types of working by using a continuous or discontinuous process can be provided.

The first operating step provides for the operator O to guide the vehicle 3—for example by means of a remote control-in the work area, to a position suitable to start the process. In this condition, robot 2 is in a rest position and in a safe condition: no movement of robot 2 is allowed by the control logic. According to a safety protocol, in this step the operator O is located behind the vehicle 3 and in front of the vertical support portion 21 of the trolley 13.

Once a desired positioning has been carried out, the operator O selects a parking command. This command provides for the actuation of the stabilizers 20, to stably park the vehicle 3. In this condition, movement of the robot 2 is therefore allowed.

Once the position of the vehicle 3 has been defined, said second operating step begins: the operator O selects an operating area by means of the human-machine interface 12, indicating where the bulkheads surrounding the work area are located (for example, indicating the relative distance between the vehicle 3 and the bulkheads). This information is used to selectively activate some safety systems (not shown), to limit the work area of robot 2. The operator O also indicates the region of interest of the operating area for carrying out the welding (for example by indicating a weld on the right, left or front side, with respect to the orientation of the vehicle 3). The final confirmation of the selected configuration is given by the operator O via a button located near the human-machine interface 12. Once the selection has been confirmed, the human-machine interface 12 allows proceeding to the next operating step. In other words, the operator O will have to select the configuration of the bulkheads of the work environment, before proceeding further in defining the working cycle.

Subsequently, the operator O defines various working parameters and the welding trajectories. In this regard, as previously indicated, a plurality of predetermined work programs is contained in a memory accessible by the electronic controller E. For example, the work programs can be selected with various icons which schematically represent different types of working. In the case of an operating head 4 for performing welding operations, each of work programs includes information about a predetermined configuration of welded joint and a plurality of welding parameters associated with said predetermined configuration of welded joint.

The operator O carries out a preliminary selection-by means of the human-machine interface 12—of one of the predetermined work programs, among a plurality of available predetermined programs (offline programming phase).

Preferably, each work program identifies:
a type of joint (for example with reference to a ship under construction, bulkhead-deck or bulkhead-reinforcement);
a specificity of the joint, for example:
presence of obstacles at the initial point, the end point or an intermediate position;
corrugated bulkhead instead of smooth;
intersecting bulkheads.

As illustrated in FIG. 4, the human-machine interface 12 shows a related simplified graphic illustration 39 for each work program. Depending on the selection made, it may be necessary to enter additional information to complete, for the execution of the welding (for example, indicating the sheet thickness, joints with/without welding gap, number of passes).

After confirmation of the predetermined work program, the robot 2 moves towards a specific approach position of each program and dependent on the work region, so as to facilitate the subsequent phase of acquisition of the working points.

Subsequently, the operator O uses the programming tool 5 to provide an information to the robot controller E about the position in the space of the working points at which the operating head 4 has to operate. In the case that the programming tool 5 comprises the marker device described above, the operator O uses the marker device to indicate, by means of the pointer element 9, an initial point of a process trajectory (in the case of a continuous process).

As illustrated in FIG. 5, the human-machine interface 12 suggests which points to acquire and the sequence, based on the previous selections. The operator O will have to identify, by placing the marker, the points previously displayed, which have the purpose of identifying the initial and end point of the weld and defining the geometry of any obstacles.

The vision device 6 detects the position of the pointer element 9 and the robot 2 moves automatically bringing the operating head 4 towards the point indicated by the pointer element 9. The system S is configured to operate so that the robot 2 follows the position of the marker continuously, in real time and at a safe speed. Robot 2 will follow the marker keeping a fixed distance and maintaining a reduced speed for safety reasons (<250 mm/s.). The marker must always be framed by the vision device 6.

The system S provides an automatic refinement step of the learning of the robot 2 wherein, by means of the opto-electronic detection system 10, the robot 2 is controlled to move the operating head 4 at a position closest to said working points, always with the vehicle 3 kept stationary, so as to determine more precisely the spatial position of the working points. This refinement step can be performed before or at the same time as the execution of the selected work program. The working points can then be refined, possibly establishing a differential offset with respect to the previous manual selection.

It should be noted that, following said refinement step, the optoelectronic device 10 is also configured to verify the feasibility and consistency of the selections made by the operator O with respect to the points actually acquired and the identification components of these points. In other words, a reachability test is carried out for each working point, to ensure that the welding is carried out correctly.

Preferably, a visual signal by means of LEDs mounted on the vehicle 3 indicates whether the working point is consistent with the work environment and the selected parameters. In case the selected point is beyond the reachability radius of robot 2, the possible alternatives are:
reducing the operating area by selecting closer points, or
performing an “abort the cycle” procedure to return robot 2 to its rest position, without carrying out the subsequent steps.

At the end of the refinement step with the opto-electronic device 10, the operating head 4 is automatically controlled to move along the processed work trajectories, carrying out the planned working.

According to a preferred embodiment, the system S is configured to memorize the performed working cycles, and all the related parameters, in order to possibly be able to subsequently evaluate the performed operations in a view of quality control of the performed working.

According to a further embodiment, the system S comprises a fleet of mobile robotic units 1, configured to work simultaneously and in a coordinated manner in a work area, wherein the fleet is controlled by a central electronic unit according to a logic control to manage the simultaneous movement of the mobile units 1.

Thanks to the feature described above, the system S according to the invention allows to carry out multiple operations of a continuous or discontinuous process in a simple, fast and extremely intuitive way for the operators.

Of course, without prejudice to the underlying principles of the invention, the details of construction and the embodiments may vary widely with respect to what has been described and illustrated, without thereby departing from the scope of the present invention, as defined in the appended claims.

1. A method for carrying out construction and/or assembly and/or maintenance and/or repair and/or inspection operations within a work environment, with the aid of a mobile robotic unit,
wherein the mobile robotic unit comprises:
a multi-axis manipulator robot carrying an operating head,
a vehicle carrying said robot, configured to be wire-guided or remote-controlled by an operator, or equipped with autonomous driving,
wherein the method comprises the steps of:
moving the vehicle up to a work area in the work environment, and locking the vehicle at a position in the work area,
starting a learning phase of the robot, wherein the operator, with the aid of a programming tool, provides an information to an electronic controller about the position in a space of a plurality of working points at which the operating head has to operate,
processing, through said electronic controller, a plurality of work trajectories of the operating head on the basis of the information acquired on the position in the space of the working points and also on the basis of a selection made by the operator, through a human-machine interface, from a plurality of predetermined work programs workable by the operating head, and contained in a memory accessible by said electronic controller, and
starting the selected work program, wherein said operating head is automatically controlled to move along the processed work trajectories.

2. The method according to claim 1, wherein at least one opto-electronic detection system for assisting the robot is associated with said operating head, and subsequently to said learning phase, and before or at the same time as the execution of the selected work program, an automatic refinement step of the learning of the robot is performed, wherein the robot is controlled to move the operating head bringing said at least one opto-electronic detection system at a position closest to said working points, while the vehicle is kept stationary, and wherein, with the aid of said at least one opto-electronic detection system, the spatial position of the working points is determined more precisely.

3. The method according to claim 2, wherein each of said work programs includes information on a specific type of operation to be performed and a plurality of work parameters associated with said specific type of operation.

4. The method according to claim 3, wherein the selection of said work programs is carried out prior to using said programming tool.

5. The method according to claim 2, wherein during said refinement step, the work area is detected with the aid of said opto-electronic detection system in such a way as to determine, if necessary, corrections to be made to the operating parameters that are part of the selected work program.

6. The method according to claim 1, wherein said programming tool used in the learning phase comprises a marker device which is manually operated by an operator to make a plurality of working points at said work area recognizable by a vision device carried by the robot.

7. The method according to claim 6, wherein said marker device is a rod operable by the operator and having an end portion comprising a pointer element recognizable by said vision device.

8. The method according to claim 1, wherein the electronic controller is carried by a service trolley operatively connected to the vehicle, and also connected to a service unit via at least one connection cord-including cables and service pipes.

9. The method according to claim 2, wherein said at least one opto-electronic detection system for assisting the robot comprises an emitting device configured to project a laser light blade onto the work area and a receiver device for acquiring the reflected radiation.

10. The method according to claim 1, wherein said operating head is configured to perform an operation chosen from: welding, riveting, screwing, cutting, deposition of sealant, addition of material by means of additive manufacturing technology.

11. The method according to claim 10, wherein the operating head is configured to perform arc welding operations.

12. The method according to claim 3, wherein the operating head is configured to perform arc welding operations and in that each of said work programs includes information about a predetermined configuration of welded joint and a plurality of welding parameters associated with said predetermined configuration of welded joint.

13. A system for carrying out construction and/or assembly and/or maintenance and/or repair and/or inspection operations within a work environment, for example within a ship structure or floating or semi-submersible offshore structures or inside an aircraft or inside a building structure or in an outdoor space,
wherein said system comprises a mobile robotic unit including:
a multi-axis manipulator robot carrying an operating head and associated with an electronic controller,
a vehicle carrying said robot and configured to be wire-guided or remote-controlled by an operator, or equipped with autonomous driving, so as to be moved up to a predetermined work area in the work environment, and then locked at this position,
wherein said system comprises a programming tool, usable by an operator and configured to provide an information to the electronic controller about the position in the space of a plurality of working points at which the operating head has to operate,
said electronic controller being further configured for:
processing a plurality of work trajectories of the operating head on the basis of the information acquired on the position in the space of the working points and also on the basis of a selection made by the operator, through a human-machine interface, from a plurality of predetermined work programs workable by the operating head, and contained in a memory accessible by said electronic controller, and
executing the selected work program, wherein said operating head is automatically controlled to move along the processed work trajectories.

14. The system according to claim 13, further comprising:
at least one opto-electronic detection system for assisting the robot, associated with said operating head,
said electronic controller being also configured to perform, subsequently to said learning phase, and before or at the same time as the execution of the selected work program, an automatic refinement step of the learning of the robot, wherein the robot is controlled to move the operating head bringing said at least one opto-electronic detection system at a position closest to said working points, while the vehicle is kept stationary, and wherein, with the aid of said at least one opto-electronic detection system, the spatial position of the working points is determined more precisely.

15. The system according to claim 14, wherein said programming tool used in the learning phase comprises a marker device which is configured to be manually operated by an operator to make a plurality of working points recognizable at said work area by a vision device carried by the robot.

16. The system according to claim 15, wherein said marker device is a rod operable by the operator and having an end portion comprising a pointer element recognizable by said marking device vision carried by the robot.

17. The system according to claim 14, wherein said at least one opto-electronic detection system for assisting the robot comprises an emitting device configured to project a laser light blade onto the work area and a receiver device for acquiring the reflected radiation.

18. The system according to claim 13, wherein said operating head is configured to perform an operation chosen from: welding, riveting, screwing, cutting, deposition of sealant, addition of material by means of additive technology manufacturing.

19. The system according to claim 13, wherein the operating head is configured to perform arc welding operations.

20. The method of claim 1, wherein the work environment comprises an environment within a ship structure or floating or semi-submersible offshore structures or inside an aircraft or inside a building structure or in an outdoor space.
